(19) United States
(12) Patent Application Publication
(10) Pub. No.: US 2016/0140844 A1
(43) Pub. Date: May 19, 2016

(54) Device and Method for Monitoring Vehicles

(71) Applicant: GRUPPO POTENTE LTD, NAIROBI (KE)

(72) Inventor: MBUGUA NJIHIA, NAIROBI (KE)

(21) Appl. No.: 15/004,955

(22) Filed: Jan. 24, 2016

Related U.S. Application Data
(63) Continuation of application No. PCT/KE2014/000034, filed on Jul. 24, 2014.

(30) Foreign Application Priority Data
Jul. 25, 2013 (KE) KE/P/2013/001880

(51) Int. Cl. G08G 1/127; G06Q 40/08

(52) U.S. Cl. CPC G08G 1/127; G06Q 40/08

(57) ABSTRACT

In various embodiments, the invention relates to the electronic device arts. In an aspect, there is provided a tag device for storing vehicle insurance information and tracking the location of the vehicle comprising: a backing member configured to be affixed to a surface of the vehicle; a visual code disposed on the backing member, wherein the visual code is machine readable and is associated with a unique tag identification (ID) code; a locator device disposed on the backing member, wherein the locator device is configured to determine a location and communicate the determined location; a power source disposed on the backing member and configured to provide power to the locator device; and a reserve power source disposed on the backing member and configured to receive power from the power source and further configured to provide power to the locator device and/or to the power source.

### PRIORITY CLAIM TO RELATED APPLICATION

This application claims priority to PCT/KE2014/000034, filed 24 Jul. 2014, which application claims priority to Kenyan application KE/P/2013/001880, filed 25 Jul. 2013. The disclosures of such applications are incorporated herein by reference.

### TECHNICAL FIELD

In various embodiments, the invention relates to the electronic device arts.

### BACKGROUND

Motor vehicle-related activities form a large part of the economy of developing and developed economies. Personal use of motor vehicles often accounts for a significant percentage of disposable income of a typical household. Commercial transport of goods (via freight vehicles) and people (via taxis and the like) are often vital links within an economy. In most countries, all of these vehicles are required to carry insurance as they operate on the roads. The insurance industry takes great effort to estimate the risk of payment-triggering events (road accidents, vehicle thefts, etc.) for a great variety of vehicles. Such estimates are typically based on historical data for similar vehicles and drivers, and are often significantly imprecise. Furthermore, the estimates do not account for actual usage and environment of operation of the specific vehicle being insured. An improved method for insuring motor vehicles based on actual usage is desirable.

Relevant art: US 2010/0131303; US 2012/084179; US 2012/0330690; and US 2012/0241516.

### SUMMARY OF THE INVENTION

In an aspect, there is provided a tag device for tracking a vehicle comprising: a backing member configured to be affixed to a surface of the vehicle; a visual code disposed on the backing member, wherein the visual code is machine readable and is associated with a unique tag identification (ID) code; a locator device disposed on the backing member and configured to determine a location of the vehicle, wherein the locator device is configured to communicate the determined location and the ID code to a remote server or to an optional communication device, wherein, when present, the optional communication device is disposed on the backing member and is configured to communicate the determined location and the ID code to a remote server; a power source disposed on the backing member and configured to provide power to the locator device; and a reserve power source disposed on the backing member and configured to receive power from the power source and further configured to provide power to the locator device and/or to the power source.

In embodiments:
the locator device comprises a SIM card and is configured to communicate the determined location and the ID code to the remote server via a cellular network;
the locator device comprises a GPS device;
the optional communication device is present and comprises a SIM card configured to communicate via a cellular network or a transmitter configured to communicate via a satellite network;
the visual code is a 2D barcode;
the power source is a solar cell;
the reserve power source is a capacitor; and
the tag device further comprises identification information printed on the backing member, and wherein the identification information comprises a verification phone number and/or a verification SMS short code, and the unique tag ID code.

In an aspect, there is provided a system for providing insurance for a vehicle belonging to a user, the system comprising: the tag device as above; and a remote server, wherein the tag device is configured to communicate information to the remote server, and wherein the remote server is configured to record information received from the tag device.

In embodiments, the system further comprises a code reader device configured to read the visual code of the tag device.

In an aspect, there is provided a method for monitoring the location of a vehicle having the tag device of claim 1 affixed thereto, the method comprising: determining an instantaneous location of the vehicle using the locator device; optionally communicating the instantaneous location to a communication device; transmitting the instantaneous location and unique tag ID code to a remote server; and recording on the server the instantaneous location of the vehicle and the unique tag ID code.

In an aspect, there is provided a method for providing an insurance product to a user having a vehicle with a tag device as above affixed thereto, the method comprising: receiving at a remote server a request for an insurance product, wherein the request comprises: the insurance product type; a payment confirmation; and the unique user ID code associated with the tag device; confirming that the request is valid; and updating a record stored in the server to reflect the request, wherein the record is associated with the unique user ID code.

In an aspect, there is provided a method for monitoring compliance with a rule by a vehicle having a tag device as above affixed thereto, the method comprising: determining an instantaneous location of the vehicle using the locator device; optionally communicating the determined instantaneous location to a communication device; transmitting the determined instantaneous location and unique tag ID code to a remote server; determining that the determined location requires compliance with a rule; and notifying a user of the requirement for compliance and one or more options for complying with the requirement.

In embodiments:
the rule is a parking rule, such as a fee for parking;
the rule is a toll for a toll road, bridge, or other passageway;
the rule is an insurance requirement for a specific location;
determining that the determined location requires compliance with a rule comprises a communication between the remote server and a third party (e.g. to determine a fee or other requirement);
the method further comprises receiving by the remote server information that the user has paid the required fee or otherwise complied with the requirement;
the information received by the server comprises payment information from a third party such as a mobile money provider;
the method further comprises receiving by the remote server instructions from the user, the instructions including payment or purchase instructions to comply with the requirement; and
the method further comprises re-notifying the user after an elapsed length of time or after the tag device communicates a second instantaneous location that is distant from the first instantaneous location.

In an aspect, there is provided a method for monitoring compliance with a rule by a vehicle having a tag device as above affixed thereto, the method comprising: determining an instantaneous location of the vehicle using the locator device; optionally communicating the determined instantaneous location to a communication device; transmitting the determined instantaneous location and unique tag ID code to a remote server; determining that the determined location requires compliance with a rule; and initiating a payment or purchase for complying with the requirement.

In embodiments, the initiating a payment or purchase for complying with the requirement comprises initiating a payment from an account linked to the tag device (e.g., a mobile money account) to a third party payment receiver (e.g., a toll-collection entity).

In an aspect, there is provided a tag device for tracking a vehicle comprising: a backing member configured to be affixed to a surface of the vehicle; a visual code disposed on the backing member, wherein the visual code is machine readable and is associated with a unique tag identification (ID) code; a locator device disposed on the backing member and configured to determine a location of the vehicle, wherein the locator device is configured to communicate the determined location and the ID code to a remote server or to an optional communication device, wherein, when present, the optional communication device is disposed on the backing member and is configured to communicate the determined location and the ID code to a remote server; and a power source disposed on the backing member and configured to provide power to the locator device.

In embodiments, the device as above comprises a memory chip for storing bulk data. The memory chip can be configured to communicate with the communication device so as to communicate a bulk set of data to the remote server.

These and other aspects of the invention will be apparent from the disclosure provided here, including the claims and figures.

### BRIEF DESCRIPTION OF THE DRAWINGS

FIG. 1 is a flowchart depicting different steps of the process to update the remote server with a determined position and optional layering of additional data to build intelligence and update records in accordance with aspects of the present invention.

FIG. 2 is a flowchart depicting different steps of the process to purchase or update an insurance product in accordance with aspects of the present invention.

FIG. 3 is a flowchart depicting different steps of the process to provide insurance cost bids to a user in accordance with aspects of the present invention.

FIG. 4 is a flowchart depicting different steps of the process to update the remote server when the tag device enters a fee-charging location.

### DETAILED DESCRIPTION OF VARIOUS EMBODIMENTS

In an aspect, there is provided a tag device for storing vehicle insurance information and tracking the location of the vehicle comprising: a backing member configured to be affixed to a surface of the vehicle; a visual code disposed on the backing member, wherein the visual code is machine readable and is associated with a unique tag identification (ID) code; a locator device disposed on the backing member, wherein the locator device is configured to determine a location and communicate the determined location; a power source disposed on the backing member and configured to provide power to the locator device; and a reserve power source disposed on the backing member and configured to receive power from the power source and further configured to provide power to the locator device and/or to the power source.

The tag device comprises a backing member configured to be affixed to a surface of the vehicle. The backing member provides structural support for other components (e.g. locator device, power source, etc.) of the tag device. In embodiments, the backing member has two surfaces—an exposed surface and an interior surface. The tag device is configured such that, when the tag device is affixed to a surface of the vehicle, the exposed surface is visible from outside of the vehicle (or, in the case of motorcycles and other vehicles lacking an enclosed passenger/cargo space, the exposed surface is visible). In embodiments, the interior surface faces into the vehicle and may not be visible from outside the vehicle. In embodiments, the interior surface is disposed against a solid non-transparent surface such as a vehicle body panel and is not visible from any location. For example, in embodiments, the backing member is configured to be affixed to a windscreen or other window of the vehicle, such that the exposed surface is visible to a viewer from outside of the vehicle, and the interior surface is visible to a viewer from inside the vehicle. In embodiments, the backing member is configured to be affixed to a vehicle body panel such that the exposed surface is visible to a viewer (i.e., any viewer in, on, or off of the vehicle) and the interior surface is not visible to a viewer.

In embodiments, the backing member comprises an adhesive material on a surface of the backing member. The adhesive material is sufficient to affix the tag device to a surface of the vehicle. In embodiments the adhesive is sufficient to create a permanent bond of the tag device to the surface of the vehicle, wherein “permanent” means that chemical (e.g., a solvent) or mechanical (e.g., a razor blade) means is required to remove the adhesive and the tag device. In embodiments, the adhesive material is disposed on the exposed surface. This embodiment is suitable where the tag device is to be affixed to the interior of a window such as a windscreen. In such embodiments, the adhesive may be disposed around the perimeter of the backing member. The adhesive may also be disposed at any point of the backing member that is configured to touch the surface to which the backing member is to be affixed, such as points between the components of the tag device (e.g., around the power source, around the locator device, etc.). Provided that the adhesive is transparent, the adhesive may also be disposed over any printed matter on the backing member such as the visual code, etc.

In embodiments, the backing member is paper, waxed paper, plastic, laminate, or another sheet material, or any combination thereof. The backing member is sized and shaped for appropriate affixation to the vehicle. In embodiments, the backing member is rectangular, square, triangular, or circular. In embodiments, the longest dimension of the backing member (e.g., the diameter where circular, the width where rectangular, or a side length where square) is in the range of 2-25, or 5-20, or 10-15 cm, or is less than or equal to 25, 20, 15, or 10 cm, or is greater than or equal to 2, 5, 10, 15, or 20 cm. The backing member may be any color provided that it does not obscure any printed matter on the backing member such as the visual code. For example, the backing member may be white, beige, or transparent. The backing member may be of any suitable thickness (where “suitable” means that the backing member is of sufficient thickness to serve the functions of the backing member as described herein), such as the thickness of 0.003-0.2 inches, or 0.005-0.1 inches, or 0.01-0.1 inches.

The backing member is configured to be affixed to any suitable surface of the vehicle. A suitable surface is one where the tag device will be visible to an observer outside of the vehicle, and the communication device, power source, and locator device of the tag device are able to function as designed and described herein (e.g., the power source is exposed to sun, the locator device can receive GPS signals, etc.). Examples of suitable surfaces are: the windscreen (inside or outside, preferably inside); the rear window or any other window provided that the tag device will not be damaged if a window is opened; and a body panel such as the gas tank of a motorcycle, or the bonnet or boot of an automobile. In embodiments, the surface is the inside of the windscreen such that the tag device is visible to an observer outside of the vehicle.

The tag device comprises a visual code disposed on the backing member. The visual code can be any code capable of encoding information. Examples of visual codes are linear barcodes and 2D barcodes (QR Code, Aztec Code, High Capacity Color Barcode, etc.). In embodiments, the visual code is a 2D barcode. In embodiments, the visual code is a QR Code.

In embodiments, the visual code encodes a data-storage location. For example, the data storage location may be a website, and the visual code then encodes the URL for that website. For example, the data storage location may be a server or other device with an IP address, and the visual code then encodes the IP address. For example, the data storage may be an entry in a database on a website, and the visual code then encodes the URL of the website and an identification element of the specific entry in the database. The visual code is capable of being read by a code reader (such as a smart phone with a QR code reader, etc.) such that the reader is directed to the corresponding data-storage location.

In embodiments, the data-storage location encoded by the visual code stores a variety of information, such information including but not limited to: vehicle type; insurance status; vehicle registration (VIN and license number); start date and time of insurance cover (e.g. using International Standard ISO 8601); end date and time of Insurance cover (e.g., using International Standard ISO 8601); name of insurance cover provider; phone number of insurance cover provider; parking ticket status; start date and time of parking fee (e.g., using International Standard ISO 8601; and end date and time of parking fee (e.g., using International Standard ISO 8601).

The visual code is disposed on the backing member. In embodiments, the visual code is directly printed onto the backing member, or the visual code is printed on a separate substrate that is then affixed to the backing member. In embodiments, the visual code is printed directly onto the exposed surface of the backing member.

The tag device comprises a locator device that is capable of determining the geographic location (i.e., coordinates and, optionally, elevation) of the tag device from geo-location signals (also referred to herein simply as “signals”). In embodiments, the locator device is a Global Positioning System (GPS) device, and the geo-location signals are transmissions from GPS satellites. GPS devices include dedicated GPS devices as well as GPS-enabled devices. In embodiments, the locator device is capable of determining a geographic location based on signal(s) received from a cellular network, and the geo-location signals are transmissions from cellular network transmitters (e.g., cell towers).

In embodiments, the locator device is a transceiver, such that it receives and transmits via a cellular network. For example, the locator device comprises a SIM card and associated circuitry allowing the locator device to receive information from a cellular network, determine a location based on such information, and transmit the determined location via the cellular network. The locator device can be configured to communicate with any cellular network, such as GSM, UMTS, and/or CDMA, and/or can be configured to communicate via Bluetooth, wifi, infrared, RF, and the like.

In embodiments, the locator device is a receiver only, and receives geo-location signals from a network (e.g., a GPS network or a cellular network) in order to determine a geographic location. The locator device as a receiver only is then configured to communicate a determined geographic location to a communication device of the tag device.

Determination of a location by the locator device can be configured to occur at regular intervals (such as less than or equal to every 1, 5, 10, 15, or 30 minutes) or at random intervals. Alternatively or in addition, the locator device can be configured to determine a location on demand, i.e., when requested by a remote server or other control element. Furthermore, the locator device can be configured to determine a location in a context-specific frequency. For example, when the locator device senses movement (e.g., a determined location is different from the immediately-prior determined location), the frequency of determination of location can be increased.

In embodiments, the tag device comprises a communication device. The communication device is disposed on the backing member and is configured to: receive the determined location from the locator device, and communicate the determined location via a satellite, a cellular network, or both. In embodiments, the communication device comprises a SIM card and associated circuitry for communicating with a cellular network. For example, the SIM card can be a machine to machine (M2M) SIM card. In embodiments, the communication device is a transmitter configured to communicate with a satellite.

In embodiments where the locator device comprises a SIM card, a separate communication device is optional (because the locator device is itself capable of communicating a determined location to a remote server). In embodiments where the locator device is a GPS device, a separate communication device is necessary so that a determined location can be communicated to a remote server as described herein.

The tag device comprises a power source disposed on the backing member and configured to provide power to the locator device. Where a communication device is present, the power source is also configured to provide power to the communication device. In embodiments, the power source of the tag device is a connection (e.g., wires) configured to connect to an external power source such as a battery or alternator in the vehicle. In embodiments, the power source is a solar cell configured to generate power from incident light. The light can be direct or indirect, and can have a natural source (i.e., the sun) or an artificial source (e.g., parking lot or street lighting). The power source is selected to generate sufficient power to operate the locator device and, when present, the communications device, as well as to charge the reserve power source. In embodiments, the power source provides power in the range 0.05-0.5, or 0.1-0.3 Watts, or greater than or equal to 0.05, 0.1, 0.15, 0.2, 0.3, or 0.4 Watts, or less than or equal to 0.5, 0.4, 0.3, 0.2, 0.15, or 0.1 Watts peak power. Where the power source is a solar cell, the dimensions of the solar cell are selected to provide the necessary power, and the shape of the solar cell is selected to fit the backing member while providing sufficient space for the other components. For example, the cell may be square with dimensions of 5×5 cm, or circular with a diameter of 5 cm.

In embodiments, the tag device comprises a reserve power source. The reserve power source is disposed on the backing member and provides power to the locator device and, when present, to the communication device, when the power source is not generating power (or is not generating sufficient power). For example, where the power source is a solar cell, the power source will not provide power (or may not provide sufficient power) in low-light situations such as at night or in a garage. At such times, the reserve power source continues to provide sufficient power for determination and communication of location. In an embodiment, the reserve power source is a battery. In an embodiment, the reserve power source is a capacitor. In embodiments, the reserve power source is selected such that, when fully charged, it provides sufficient power to operate the locator device (and optional communication device) for up to 6, 8, 10, or 12 hours.

In an embodiment, the circuitry of the tag device is laid out such that the power source is directly connected only to the reserve power source, and the reserve power source is directly connected to the locator device (and optional communication device). In such embodiments, only the reserve power source provides power to the locator device and communication device. In an alternative embodiment, both the power source and the reserve power source are connected to the locator device and communication device, such that the locator and communication device can draw power from either the power source or reserve power source.

In embodiments, the tag device comprises a memory chip. The memory chip is configured to receive and store data from the locator device. The memory chip comprises non-volatile memory sufficient to store data from the locator device over a period of time such as at least 1, 2, 3, 4, 6, 9, or 12 hours. Thus, the memory chip can be used in place of or as a backup to the reserve power source. When the reserve power source is exhausted, the memory chip can store data from the locator device until the power source is again able to power the communication device (at which time the stored date is sent in bulk to the remote server).

In embodiments, the tag device does not comprise a reserve power source. In such embodiments, the memory chip is present and enables the tag device to communicate blocks of stored information when the power source is able to supply enough power to the communication device.

In embodiments, the tag device comprises identification (ID) information disposed on the exposed surface of the backing member (or on a surface that is affixed to the exposed surface of the backing member). In embodiments the ID information is printed onto the backing member. The ID information is positioned so as to be visible from anywhere that the exposed surface of the backing member is visible. The ID information is “public” information inasmuch as it can be observed by non-interested parties. Thus, in embodiments, the ID information does not include any private information. Private information includes, for example, the vehicle owner's name and address, prior or current account balances or insurance types, and the like. The public ID information that is disposed on the backing member for public viewing includes information selected from the following: a verification phone number (to be used as a voice, SMS, or USSD number); a verification SMS number or SMS short code; a verification USSD number; instructions for verifying insurance coverage or verifying other information; and the unique tag ID code associated with the tag device.

Each tag device is assigned a unique tag ID code. In embodiments, the visual code of a tag device encodes the unique tag ID code for that tag device. The locator device and/or the communication device is configured such that outgoing communications are stamped or otherwise associated with the tag ID code of the tag device.

When a tag device is assigned and affixed to a vehicle, the tag ID code is associated with the personal identification information of the vehicle owner (referred to herein as the “user”) and with the identification information of the vehicle. Users can be private individuals, companies, governments, or the like. Such user information may include, for example, the user's name and address, the user's phone number, and the like. The vehicle information is mentioned herein and includes vehicle license number, vehicle identification number (VIN), vehicle type (make and model), and the like. The tag ID code will also be associated with insurance information, parking ticket information, and other relevant information for the assigned vehicle. All of this information will be stored in a database or other electronic structure on a remote server as described herein. Assignment of the tag ID code to this information is done at or after the time that the tag device is affixed to a particular vehicle. Accordingly, the tag devices can be manufactured as a generic device that can be assigned to any vehicle/user at the point of purchase or after purchase (i.e., when the remote server is updated). Furthermore, the unique tag ID code is mapped to the personal identification information of the user and the identification information of the vehicle. Therefore, when a user carries out an operation that requires update of the information associated with the tag device, such as purchasing an insurance product, the user can provide any of the personal identification information or vehicle identification information that maps to the user's tag device. For example, the user can provide the phone number or VIN associated with the tag device.

In embodiments the tag device also comprises an RFid sensor. The RFid sensor can operate in both passive and active state, and in embodiments comprises a vibration component. The sensor will allows the provision of toll collections for county governments from vehicles using certain roads. On a prepaid or post paid model, users can load a wallet that will be used to pay for toll fees or parking fees. For example RFid readers can be set up on roads and parking spaces, with deductions done automatically if on prepaid and payment alerts sent if on post paid or if wallet runs low. There may be different toll charges on different stretches and the readers will be set up in the tunnels, so as cars travel by, the necessary deductions (or payment trigger notifications) are done in realtime. Also, the device provides second level authentication of location as the RFid readers will be in known locations. For example if a car is reported as stolen, the RFid readers positioned on highways will be able to provide secondary location verification. Furthermore, the vibration component will capture data that will allow us to determine the state of the road. For example the location of hazards such as potholes can be detected, or detection of an impact of a collision as would happen during an accident. A gyroscope sensor may be part of the vibration component or a separate component, and the sensor allows capture of changes in the vehicles “equilibrium” state in real time. All this data may be patched over to the backend in real time where the data crunching will happen.

### Systems for Monitoring and Providing Insurance

In an aspect, there is provided a system for providing insurance for a vehicle belonging to a user, the system comprising: the tag device as described herein; and a remote server, wherein the tag device is configured to communicate information to the remote server, and wherein the remote server is configured to record information received from the tag device. The system is also suitable for tracking the movements of a vehicle. The system is also suitable for monitoring vehicle compliance with, for example, parking fees and regulations.

The system for providing insurance comprises a tag device as described herein. The tag device is affixed to the vehicle as described herein, particularly such that the power source can provide power, the locator device can determine a location of the tag device, and the device is visible.

The system for providing insurance comprises a remote server. The remote server maintains a database or other listing of active tag ID codes (i.e., tag ID codes that have been assigned to a user), and is updated periodically or any time a new tag ID code is assigned to a user. The remote server is able to receive information from the tag device via a network such as a cellular network and/or the internet. The information received includes a time-stamped determined location and the tag ID code associated with the tag device reporting the information.

The remote server contains a database or other electronic system (spreadsheet, etc.) with records for each tag device produced and/or assigned to vehicles. The information associated with a tag device can be updated anytime there is a change, or batch updates can occur at regular intervals. Changes to such information may involve any of the following actions: purchase of a tag device by a user; report of a lost/stolen/destroyed tag device; purchase of a new insurance product by the user of a tag device; renewal or modification of a previously-purchased insurance product by the user of a tag device; purchase of another product associated with the tag device (e.g., parking charges, toll charges, etc.); change of personal information of a user; and the like.

The remote server will have all of the hardware and software components needed to carry out the functionality described herein, and such components will be readily determined by one of ordinary skill in the art. For example, in embodiments the remote server is configured to communicate via the internet and/or directly via a cellular network.

The system for providing insurance may further comprise a code reader device configured to read the visual code of the tag device and to communicate with the remote server. In embodiments, the code reader device may be a dedicated device with no other functions (or a dedicated device where code reading is the primary function of the device). In embodiments, the code reader device is a cellular phone with an application installed that is suitable for reading the visual code.

The system for providing insurance may further comprise a payment platform. The payment platform can be, for example, a cellular phone-based payment platform such as M-Pesa, Airtel Money, etc. The payment platform interacts with the system for providing insurance by receiving a payment from the user or a third party and relaying payment information to the system for providing insurance. The payment information can include the payee, the account for which a payment has been made (i.e. the tag ID code or the phone number of the user associated with the tag ID code), the product for which payment has been made, and other information as appropriate. The remote server receives this information from the payment platform and updates the appropriate record associated with the tag ID code for which a payment is made.

### Methods for Monitoring a Vehicle

In an aspect, there is provided a method for monitoring the location of a vehicle having the tag device as described herein affixed thereto, the method comprising: determining an instantaneous location of the vehicle using the locator device; optionally communicating the instantaneous location to a communication device; transmitting the instantaneous location and unique tag ID code to a remote server; and recording on the server the instantaneous location of the vehicle and the unique tag ID code.

The method involves determining an instantaneous location of the vehicle using the locator device. Where the locator device is a GPS device, this involves receiving a GPS signal from a plurality of GPS satellites. Where the locator device is a SIM card, this involves receiving a plurality of cellular signals in order to triangulate a location. The locator device determines the location of the vehicle (i.e., the tag device on the vehicle) and this determined location is communicated to the remote server. Where the tag device comprises a communication device separate from the locator device (i.e., wherein the locator device is not also capable of communicating with a cellular network or satellite), the locator device communicates the determined location to the communication device, and the communication device initiates a communications link with a cellular network or a satellite. The communication device relays the determined location (along with other information identifying the source of the communication, time, etc.) to the remote server via the communications link. The remote server receives the determined location and other relayed information, and updates a database or other electronic record to reflect the newly received information. Where the tag device does not contain a separate communication device (e.g., the locator device is a SIM card and is able to communicate via a cellular network), the process is the same except the locator device communicates directly to the remote server rather than via the communication device.

The process of recording a determined location for a tag device (and therefore for the vehicle associated with the tag device) can be repeated as frequently as desired, including at variable intervals to address various situations. For example, under normal operation the tag device can update the location after a period of time between 0.1-60, 1-30, or 1-15 minutes, or at intervals greater than or equal to 0.1, 0.5, 1, 3, 5, 10, 15, 20, 25, or 30 minutes, or at intervals less than or equal to 60, 30, 25, 20, 15, 10, 5, 3, 1, or 0.5 minutes. In embodiments, the tag device determines the updated location with a frequency of less than or equal to every 60, 30, 20, 15, or 10 seconds. In embodiments, the frequency of update can be varied depending upon the time of day. For example, during late-night hours such as between 10 pm and 5 am, or between midnight and 4 am, the device can update the location at a slower interval (such as every 10, 20, 30, or 60 minutes). Similarly, slow-interval updates can be carried out during working hours (or other periods where vehicle movement is less likely) such as 9 am and 5 pm, or between 10 am and 3 pm, or the like. During commuter hours (or other hours as desired), the device can update at more rapid intervals such as those described above. It will be appreciated that, as used herein, the term “update the location” is meant to include determining of the location by the location device, communicating the determined location (and other data such as time, etc.) to the communication device (when present), communicating the determined location (and other data such as time, tag ID code, etc.) to the remote server, and updating by the remote server of a record.

The updated locations can be used to determine a profile of use for the vehicle associated with the tag device. The profile of use can be used to characterize the type of use of the vehicle (e.g., as a vehicle used primarily for recreational activities, as a vehicle used primarily for commuting to a place of work, as a vehicle used primarily for business, or the like, or combinations of such use). The location information can also be used to characterize the risk to insuring the vehicle, particularly where the tag device records frequent or prolonged trips within high-risk locations. The location information can also be used to verify that a vehicle traveled as expected (e.g., travel to a specific city if insurance is purchased for such a journey) or has not traveled as may be prohibited (e.g., travel between countries when only local insurance has been purchased). The location information can also help with law-enforcement activities, such as tracking or recovering stolen vehicles.

### Methods for Providing Insurance and Other Products

The devices and systems described herein are useful in a variety of methods, such as aiding the delivery of insurance products from third party insurance providers to the user (i.e., the owner of a vehicle having a tag device affixed thereto).

In an aspect, there is provided a method for providing an insurance product to a user having a vehicle with the tag device described herein affixed thereto, the method comprising: receiving at a remote server a request for an insurance product, wherein the request comprises the insurance product type, and the unique tag ID code associated with the tag device or information that maps to the unique tag ID code associated with the tag device. The request may further comprise any of the insurance-related information described herein, such as the insurance provider name, the duration of the insurance, the amount of insurance, and the like.

In embodiments, a third party payment provider transmits the request to the remote server after receiving a request and a payment from the user, wherein the request from the user comprises the insurance product type, and the unique tag ID code associated with the tag device or information that maps to the unique tag ID code associated with the tag device (e.g., the user phone number). The request may further include insurance-related information such as described herein. The request may further include a payment. For example, the request may instruct the payment provider to deduct the required payment associated with the insurance product from a credit account associated with the user's personal identification information (e.g., the user's phone number). Alternatively, the payment request may contain a credit card or debit card number. The third party payment provider validates the payment information provided by the user and approves or rejects the request based on the validity and sufficiency of the payment. An approved request is then transmitted to the remote server.

In embodiments, the user transmits the request directly to the remote server. The remote server then queries a credit account associated with the unique tag ID code (or with information such as a phone number that maps to the unique tag ID code) to determine whether the credit account contains sufficient funds to cover the cost of the requested insurance product. If the amount in the credit account meets or exceeds the cost of the insurance product, then the remote server approves the purchase request. Alternatively, the request can include payment information, such as a credit card or debit card number.

In embodiments, the method further comprises updating a record to reflect the request received for an insurance product. The record can be a record within a database or other data structure pertaining to the tag device. In embodiments, the record is stored on the remote server.

The methods described herein provide for purchase of an insurance product. The insurance product includes newly issued insurance products as well as renewal or modifications of previously purchased insurance products. Examples of insurance products are described herein and include vehicle insurance (liability, collision, etc.), health insurance for health-related expenses incurred from vehicle accidents or the like, property insurance for the value of the vehicle and/or vehicle contents, and the like. Valuation of the insured property (e.g., the vehicle) and the cost of the insurance can be carried out manually and/or via a machine-executed algorithm. The inputs for such valuation can be the vehicle identification information, historical data pertaining to the movements of the vehicle, locations that the vehicle spends significant amounts of time, and the like.

The insurance product type (as specified in the various requests, e.g., from the user to the payment provider, or from the payment provider to the remote server) typically identifies the insurance provider, the amount of coverage, the duration of coverage, and the location of coverage. The “location of coverage” can be a specific geographic area (e.g., a city, a country, a region, etc.), or a specific route (e.g., a highway, or a route between two addresses or landmarks). The amount of coverage can include whether the user desires liability insurance, health insurance, coverage for damage to the vehicle, and the like, and can specify payout limits for each such coverage. The duration of coverage can be any time period, such as a year, a number of months (e.g. 6, 5, 4, 3, 2, or 1 month), a number of weeks (e.g., 4, 3, 2 or 1 week), a number of days (e.g., 7, 6, 5, 4, 3, 2, or 1), or partials of any of the amounts just mentioned. Additionally, hybrid coverage can be purchased such as: “commuter coverage”—e.g., insurance coverage during commuting hours; “leisure coverage”—e.g., coverage only on weekends; “off-peak coverage”—e.g., coverage during nighttime hours or non-commuter hours, and the like. Because the tag devices and related systems described herein are capable of monitoring the location of the tag device, user compliance with the purchased insurance product type can be monitored.

In embodiments, the tag device and the information provided by the tag device to the remote server can be used to provide real-time insurance updates such as changes in the insurance carrier, changes in the insurance plan, and/or changes in the insurance amount. Suitable algorithms for such real-time updates are known in the art such as in US Patent Application number 2010/0131303.

Various third party payment providers can be utilized to carry out the inventive methods. For example, “mobile money” providers use money accounts linked to a cellular phone accounts to transfer and store money via the cellular network. Alternatively, credit card or debit card payments can be used, with the card issuer acting as the third party payment provider. Alternatively, receiving agents can be used having physical or virtual payment offices. In embodiments, the methods disclosed herein provide for confirmation that a request for an insurance product is valid, and/or confirmation that a payment is valid.

In some embodiments, the remote server contains algorithms for computing an insurance value/cost dynamically based on the real-time updated positions of a tag device and a variety of other factors such as geo-fences, road status/conditions, speed of the vehicle with the tag device, weather, and the like. Such insurance value/cost can be transmitted to various third parties such as insurance providers, for example via interactive dashboards on the Internet or cellular networks, or may be integrated into third party systems as desired.

For example, the remote server can be configured to receive real-time location-specific weather information (e.g., from an internet source such as a weather bureau). When a tag device communicates an instantaneous location to the remote server, the remote server can tag the communicated instantaneous location with weather information for that location (or for the closest location for which there is updated weather information). The remote server can then calculate a risk of accident or other insurable event based on the gathered information including weather information. Similarly, real-time traffic information, visibility information, police activity, and the like can be gathered and tagged to communicated instantaneous locations in order for the remote server to calculate more reliable and more accurate insurance values/costs. As described herein, such calculated insurance values/costs can be used to obtain real-time and variable insurance rates for users.

Vehicles suitable for the methods and devices described herein are any vehicle requiring insurance. Examples include transport vehicles such as passenger cars, SUVs, and trucks, buses, freight and delivery trucks and vans, motorcycles, off-road vehicles, boats, and the like.

In embodiments, governments could better monitor resource utilization when it comes to vehicle use by having a data source that when linked to manifests can ensure transparency and accountability by civil servants.

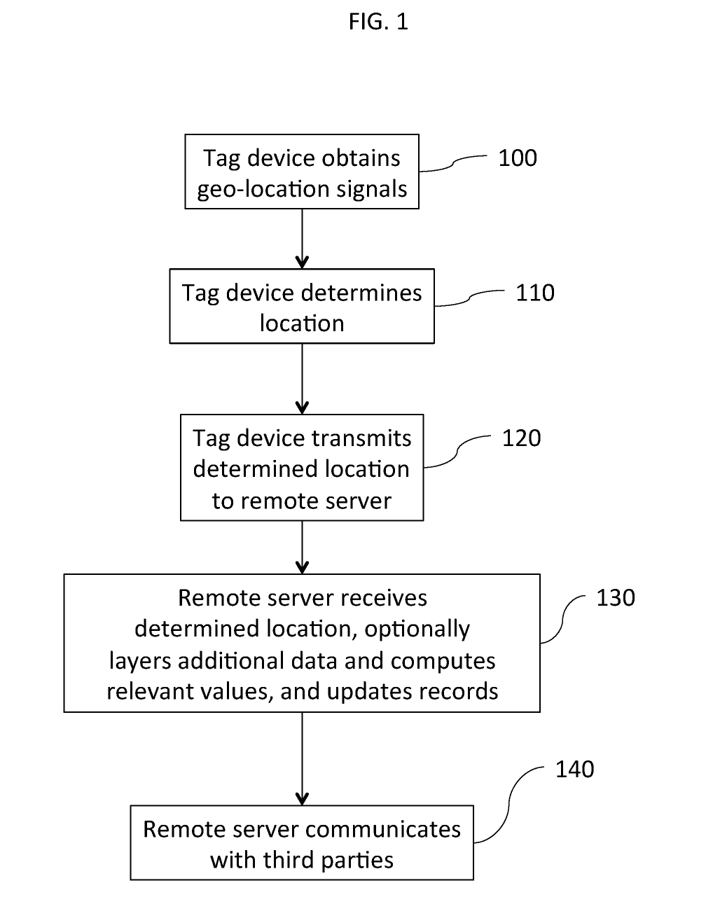

Referring to FIG. 1, a tag device (specifically, the locator device) affixed to a vehicle obtains (100) geo-location signals, such as GPS or cellular network signals. From the signals, the locator device calculates or determines (110) the current location of the tag device. The tag device then communicates (120) the determined location to a remote server. As described herein, such communication may be directly by the locator device, where the locator device is so configured (e.g., contains a SIM). Alternatively, such communication may involve the intermediary step (not shown in FIG. 1) of communicating the determined location to a communication device of the tag device from the locator device; the communication device then communicates the determined location to a remote server. The remote server receives (130) the determined location from the tag device and updates the record associated with the ID code of the tag device to include the updated location. The remote server may then, optionally, communicate (140) with third parties such as insurance providers and the like. Such communication may include the updated location and ID code of the tag device, and other information as desired. In FIG. 1, steps 100, 110, 120, and 130 may be carried out at any desired frequency, such as less than or equal to every 60, 30, 20, 15, or 10 seconds. Communication (140) with third parties can occur at the same frequency or less frequently (in the latter case, such communication may include a batch of updated data), such as less than or equal to once every day, hour, half-hour, or minute.

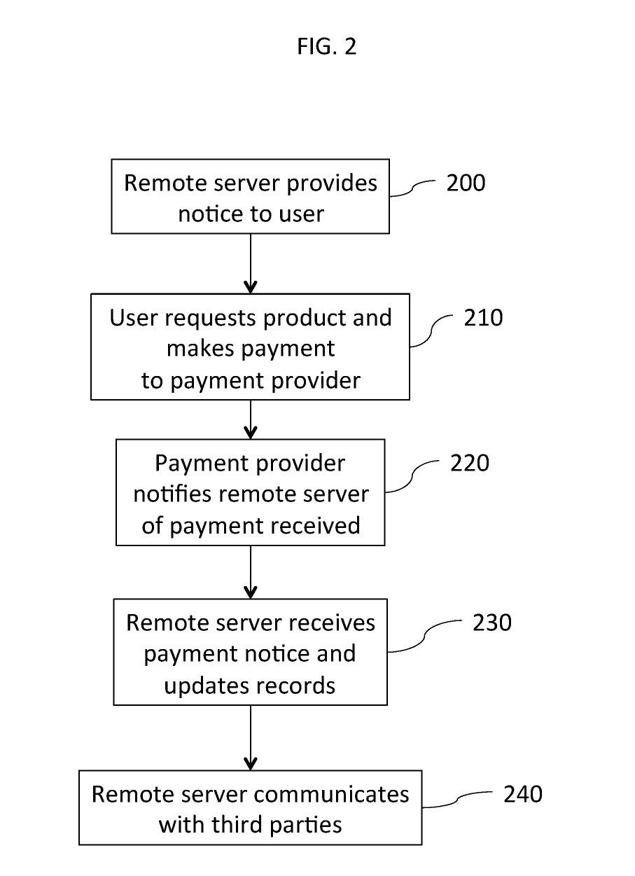

Referring now to FIG. 2, a remote server provides (200) a notice to a user. The notice can be provided by any suitable medium, such as via SMS (text), email, push notification, voice message, or the like. Example notices include the expiry or imminent expiry of an insurance or other time-limited product, a warning message that the tag device (and thus the vehicle to which it is affixed) is beyond a range (e.g., outside of a geo-fence) for which the vehicle's current insurance is valid, notification of newly available insurance products or other products, and the like. The notification can include, in embodiments, one or more options that have been determined by the remote server to be suitable to the user, and instructions for requesting such options. Such options can include, for example, insurance options and associated prices from one or more third party insurance providers. For example, the notification can include instructions for requesting a new insurance product for a time/area suggested by the remote server based on historical location data stored by the remote server, or as suggested by the current location of the tag device. Based on the notice, the user then requests (210) from a payment provider a product, and makes a payment to the payment provider. The payment provider receives the payment, and then notifies (220) the remote server of the payment received. Such notification to the remote server can include various information, including the ID code of the tag for which the product has been requested and paid, and the product that has been requested and purchased. The remote server receives (230) the notice of payment received by the payment provider, and updates the appropriate record associated with the ID code of the tag for which the product has been purchased. Optionally, the remote server then communicates (240) the updated information to a third party, such as the insurance provider offering the purchased insurance product.

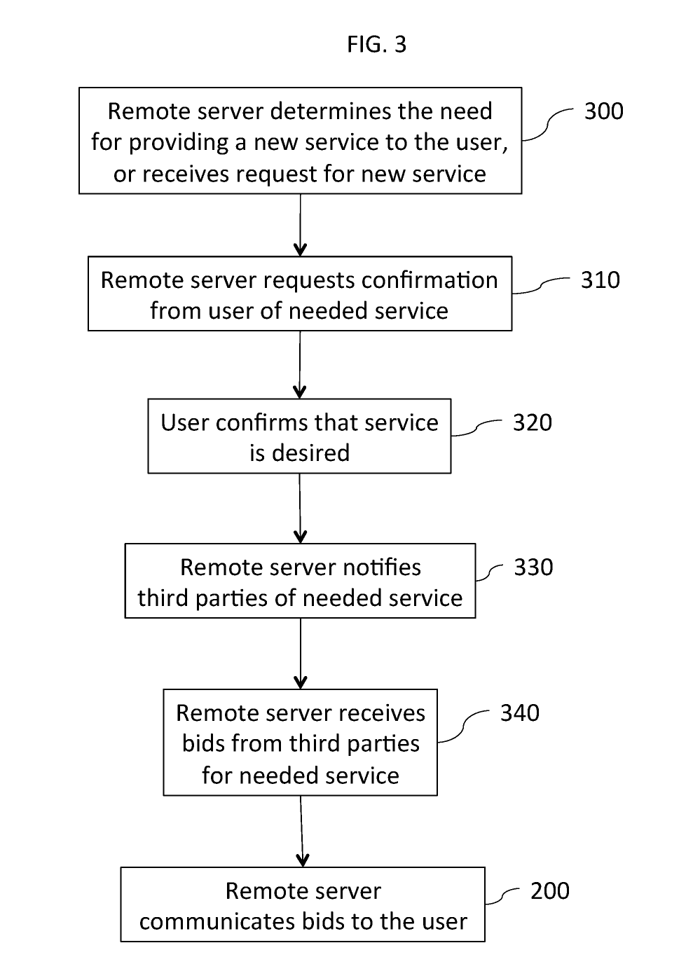

Referring now to FIG. 3, the remote server determines (300) that there is a need to provide a new product to a user, or receives (300) a request for new product from the user. The “new” product can include updates or renewals of existing products. Optionally, the remote server can request (310) confirmation from the user that the user is in need of a new product, and the user can confirm (320) that service is desired. In such response by the user, additional information can be provided such as the time duration, location, amount of coverage, etc. Based on the user's response, or (if the user is not queried for confirmation) based on a variety of data such as those mentioned herein (e.g., location of the tag device, historical movement data, etc.), the remote server notifies (330) one or more third parties of the needed service. The notice includes a request for bids from the third parties (i.e., a commitment by the third party to a price for the new service). The remote server then receives (340) bids from one or more of the third parties for the needed service. In some embodiments, the remote server communicates (200) such bids to the user in the form of a notice to the user (also, 200 in FIG. 2). Upon receipt of the notice, the user can then proceed to select a bid and pay for the bid. Such selection and payment may be fully incorporated into the notice—i.e., the notice

For example (still referring to FIG. 3), the remote server can receive (not shown in FIG. 3) a location of the tag device that is beyond the geo-fence specified by the insurance product currently covering the vehicle to which the tag device is affixed. In some embodiments, the location causes the remote server to notify the user that the vehicle has traveled beyond the current insurance coverage area, and request confirmation that additional insurance coverage is desired. The notification can also request information from the user, such as the time-duration of coverage desired, the area of coverage, and the amount of coverage desired. In other embodiments, this request for confirmation is omitted. The remote server then contacts third party insurance providers and provides the information submitted by the user, or, if the user was not contacted, then historical and other data suitable to define an insurance product. The remote server requests bids from the insurance providers and then relays the received bids to the user for selection.

Also for example (still referring to FIG. 3), the remote server can determine that an insurance product previously purchased by a user has expired or is about to expire (e.g., will expire in 7, 6, 5, 4, 3, 2, or 1 day(s)). Similarly as above, the remote server can query third party insurance providers and request for bids for the renewal or a similar insurance product, and then communicate such bids to the user upon receipt from the third parties.

The tag device can be used to enable a vehicle to follow a rule. An example of a rule is to pay a fee when entering or when remaining in a fee charging location. Examples of fee charging locations include toll roads, parking lots or on-street parking spaces, movie theaters or sporting locations, theme parks, game parks and wildlife preserves, and the like. Another example of a rule is to comply with a location-specific insurance requirement (i.e., to carry a specific amount or type of insurance). Location specific insurance requirements include out-of-country coverage or coverage for particularly hazardous locations.

In one embodiment where the rule is to pay a fee for being in a fee charging location, the fee is automatically deducted from an account linked to the tag device (such as a mobile money account of the user of a tag device) any time that the tag device determines its location to be a fee charging location. For example, the tag device determines a location and communicates the location to the remote server. The remote server cross-references the determined location with all fee charging locations, and determines that the determined location is a toll road. The remote server then initiates a payment from the account linked to the tag device to a third party such (e.g., the party in charge of collecting tolls for the toll road). This process does not require any interactions with the user. If the account linked to the tag device has insufficient funds to pay the required fee, the remote server can issue a notice to the user that a charge is due to be paid. Furthermore, if the vehicle with the tag device is traveling a distance along the toll road, a subsequent determined location will be distant from the first determined location. The tag device will communicate the distant determined location and the remote server can determine that the user is required to pay another fee (e.g., the toll road charges a toll based on the distance driven along the road, and the tag device has entered into a new section of road where the original payment no longer is valid for compliance with the toll rules). The process of confirming a payment is then repeated to ensure that the tag device remains compliant with the location-specific toll rules.

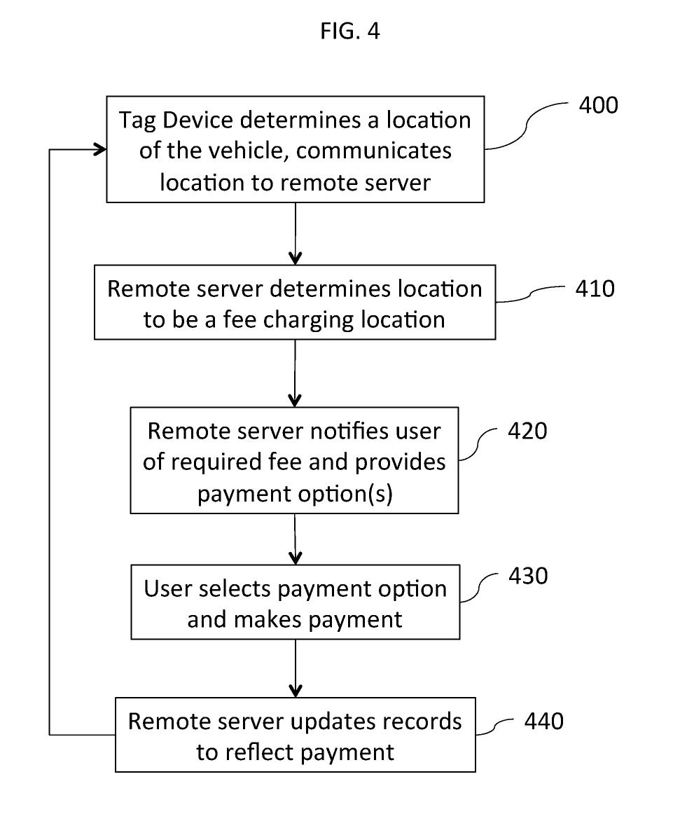

In another embodiment where the rule is to pay a fee for being in a fee charging location, the fee is not automatically deducted. Referring to FIG. 4, the tag device determines (400) a location of the vehicle, and communicates the location to the remote server. The remote server determines (410) the location to be a fee charging location. The remote server then notifies (420) the user of the required fee and provides one or more payment option(s). The user selects (430) a payment option and makes the payment (payment can be integrated into the system and facilitated by the remote server, or can be done by the user using a separate, third party payment platform). The remote server updates (440) a record to reflect the payment. In embodiments where periodic payments (top-ups) are needed, such as for parking a vehicle in a location that charges fees for units of time, the tag device will continue to determine the location (400) and the remote server can request further payments from the user as necessary.

Relevant portions of all documents cited herein are incorporated by reference. It is to be understood that while the invention has been described in conjunction with examples of specific embodiments thereof, that the foregoing description are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. Any combination of the embodiments described herein is intended to be part of the invention, as if all such combinations had been laboriously set forth in this disclosure.

What is claimed is:

1. A tag device for tracking a vehicle comprising:
a backing member configured to be affixed to a surface of the vehicle;
a visual code disposed on the backing member, wherein the visual code is machine readable and is associated with a unique tag identification (ID) code;
a locator device disposed on the backing member and configured to determine a location of the vehicle, wherein the locator device is configured to communicate the determined location and the ID code to a remote server or to an optional communication device, wherein the optional communication device is disposed on the backing member and is configured to communicate the determined location and the ID code to a remote server;
a power source disposed on the backing member and configured to provide power to the locator device; and
a reserve power source disposed on the backing member and configured to receive power from the power source and further configured to provide power to the locator device and/or to the power source.

2. The tag device of claim 1, wherein the locator device comprises a SIM card and is configured to communicate the determined location and the ID code to the remote server via a cellular network.

3. The tag device of claim 1, wherein the locator device comprises a GPS device.

4. The tag device of claim 3, wherein the optional communication device is present and comprises a SIM card configured to communicate via a cellular network or a transmitter configured to communicate via a satellite network.

5. The tag device of claim 1, wherein the visual code is a 2D barcode.

6. The tag device of claim 1, wherein the power source is a solar cell, and the reserve power source is a capacitor.

7. The tag device of claim 1, wherein the tag device further comprises identification information printed on the backing member, and wherein the identification information comprises a verification phone number and/or a verification SMS short code, and the unique tag ID code.

8. A system for providing insurance for a vehicle belonging to a user, the system comprising:
the tag device of claim 1; and
a remote server,
wherein the tag device is configured to communicate information to the remote server, and wherein the remote server is configured to record information received from the tag device.

9. The system of claim 8, further comprising a code reader device configured to read the visual code of the tag device.

10. A method for monitoring the location of a vehicle having the tag device of claim 1 affixed thereto, the method comprising:
determining an instantaneous location of the vehicle using the locator device;
optionally communicating the instantaneous location to a communication device;
transmitting the instantaneous location and unique tag ID code to a remote server; and
recording on the server the instantaneous location of the vehicle and the unique tag ID code.
